(19) United States
(12) Patent Application Publication
(10) Pub. No.: US 2014/0320399 A1
(43) Pub. Date: Oct. 30, 2014

(54) WEARABLE ELECTRONIC DEVICE AND METHOD OF CONTROLLING THE SAME

(71) Applicants: Intellectual Discovery Co., Ltd., Seoul (KR); SAYEN Co., Ltd., Gwangju (KR)

(72) Inventors: Sin-Il KIM, Seoul (KR); So-Yeon KIM, Seoul (KR); Jun-Sik KIM, Daejeon (KR); Seung-Mo JEONG, Seoul (KR)

(73) Assignees: INTELLECTUAL DISCOVERY CO., LTD., Seoul (KR); SAYEN CO., LTD., Gwangju (KR)

(21) Appl. No.: 14/266,040

(22) Filed: Apr. 30, 2014

(30) Foreign Application Priority Data
Apr. 30, 2013 (KR) 10-2013-0048610

(51) Int. Cl. G02B 27/01; G06F 3/00

(52) U.S. Cl. CPC G02B 27/017; G06F 3/005; G02B 2027/0178
USPC 345/156

(57) ABSTRACT

A wearable electronic device with a function of adjusting light transmittance, and a method of controlling the wearable electronic device are disclosed. The wearable electronic device according to an exemplary embodiment includes a transparent or light-transmitting lens, a liquid crystal installed at the lens, a camera taking a picture of a front view of a user wearing the wearable electronic device, a display part displaying an additional information to the lens, which is added to a front view recognized by the user, and a control part determining an operation mode of the wearable electronic device whether the operation mode is a transparent mode or an opaque mode, controlling liquid crystal to adjust light transmittance according to the determined operation mode, and controlling the display part to display the additional information when the operation mode is changed to be the transparent mode or the opaque mode.

### CROSS REFERENCE TO RELATED APPLICATION

This application claims priority from and the benefit of Korean Patent Applications No. 10-2013-0048610 filed on Apr. 30, 2013, which is hereby incorporated by reference for all purposes as if fully set forth herein.

### BACKGROUND OF THE INVENTION

1. Field of the Invention

Exemplary embodiments of the present invention relate to a wearable electronic device such as a glass, etc., and a method of controlling the wearable electronic device.

2. Discussion of the Background

Augmented reality is different from virtual reality in that the augmented reality shows real image overlapped with virtual object to make up for the real image, and has merits of reality in comparison with virtual reality.

In general, in order to embody the augmented reality, a head mounted display (HMD) or a head up display (HUD) is used to display various information in front of an eye of a user. Further, various researches for controlling a virtual object through a gesture recognition technology are performed.

The HMD is mounted on a head or other portion of a user and shows separated projected image to left and right eyes, respectively so that the user can feel depth due to binocular disparity when the user sees an object of view.

The HUD projects an image to a transparent glass, so that a user can recognize simultaneously outside background and information displayed through the HUD through the transparent glass.

### SUMMARY OF THE INVENTION

Exemplary embodiments of the present invention provide a wearable electronic device with polymer dispersed liquid crystal (PDLC), suspended particle device (SPD) or LC shutter installed at front side or backside of a lens to adjust light transmittance in order to operate the wearable electronic device in a transparent mode or in an opaque mode, and a method of controlling the wearable electronic device.

Exemplary embodiment of the present invention also provide a wearable electronic device which can used for an augmented reality in the transparent mode, and for enjoying contents in the opaque mode, and a method of controlling the wearable electronic device.

A wearable electronic device according to an exemplary embodiment includes a transparent or light-transmitting lens, a liquid crystal installed at the lens, a camera taking a picture of a front view of a user wearing the wearable electronic device, a display part displaying an additional information to the lens, which is added to a front view recognized by the user, and a control part determining an operation mode of the wearable electronic device whether the operation mode is a transparent mode or an opaque mode, controlling liquid crystal to adjust light transmittance according to the determined operation mode, and controlling the display part to display the additional information when the operation mode is changed to be the transparent mode or the opaque mode.

The wearable electronic device may further includes an input part receiving a user input for operating the wearable electronic device in the transparent mode or the opaque mode, wherein the input part further receives a user input for selecting a transparent level of the transparent mode or an opaque level of the opaque mode.

For example, the liquid crystal may be polymer dispersed liquid crystal (PDLC), a suspended particle device (SPD) or LC shutter, and the liquid crystal may be disposed at a front side or a backside of the lens.

The control part may determine an urgent situation by using a front view captured by the camera when the user enjoys contents in the opaque mode, and may control the liquid crystal to change the opaque mode to be the transparent mode when the control part determines that current situation is the urgent situation, stops the contents, or provides alarms to the user.

A method of controlling a wearable electronic device having a transparent or light-transmitting lens and a liquid crystal disposed at the lens to adjust light transmittance, includes capturing a front view recognized by a user wearing the wearable electronic device, determining an operation mode of the wearable electronic device to be a transparent mode or an opaque mode, controlling the liquid crystal to adjust light transmittance according to the determined operation mode, and controlling providing an additional information to the front view when the operation mode is changed to be the transparent mode or the opaque mode.

The method may further include receiving an user input for operating the wearable electronic device in the transparent mode or in the opaque mode, and receiving an user input for selecting a transparent level of the transparent mode or an opaque level of the opaque mode.

The liquid crystal may be polymer dispersed liquid crystal (PDLC), a suspended particle device (SPD) or LC shutter, and the liquid crystal is disposed at a front side or a backside of the lens.

The method may further include determining an urgent situation by using the captured front view, when the user enjoys contents in the opaque mode, and controlling the liquid crystal to change the opaque mode to be the transparent mode when the a current situation is determined to be the urgent situation, stops the contents, or provides alarms to the user.

According to the present invention, a function of adjusting light transmittance is added to a wearable electronic device to enhance convenience of a user. That is, the wearable electronic device may be used for augmented reality in the transparent mode and for enjoying contents in the opaque mode blocking background.

Further, when enjoying contents in the opaque mode, a front view is captured and provided as a sub screen, so that a user can properly deal with people around, and prepare to environment to protect the user while enjoying the contents.

Additionally, the user can be protected by alarming a user, changing the opaque mode in which a user see a contents to be the transparent mode, or stoping contents display when the present situation is attention situation or urgent situation.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 and FIG. 2 are perspective views showing a wearable electronic device according to an exemplary embodiment of the present invention.

FIG. 3 is a figure showing a view displayed to a user through the wearable electronic device.

FIG. 4 and FIG. 5 are perspective views showing a wearable electronic device according to another exemplary embodiment of the present invention.

FIG. 6 is a block diagram showing a structure of a wearable electronic device according to an exemplary embodiment of the present invention.

FIG. 7 is a schematic view showing adjustment of light transmittance of polymer dispersed liquid crystal (PDLC), suspended particle devices SPD) or LC shutter installed at the wearable electronic device according to an exemplary embodiment of the present invention.

FIG. 8 is a schematic perspective view showing SPD.

FIG. 9A is a schematic view of real image.

FIG. 9B is a schematic view of contents that is a moving picture.

FIG. 9C is a schematic view of enjoying the contents of FIG. 9B in a transparent mode.

FIG. 9D is a schematic view of enjoying the contents of FIG. 9B in an opaque mode.

FIG. 10 is a figure for explaining a selection of gray scale level in the transparent mode/the opaque mode.

### DETAILED DESCRIPTION OF THE ILLUSTRATED EMBODIMENTS

The present invention is described more fully hereinafter with reference to the accompanying drawings, in which example embodiments of the present invention are shown. The present invention may, however, be embodied in many different forms and should not be construed as limited to the example embodiments set forth herein. Rather, these example embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments of the invention are described herein with reference to cross-sectional illustrations that are schematic illustrations of idealized example embodiments (and intermediate structures) of the present invention. As such, variations from the shapes of the illustrations as a result, for example, of manufacturing techniques and/or tolerances, are to be expected. Thus, example embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present invention will be described in detail with reference to the accompanying drawings.

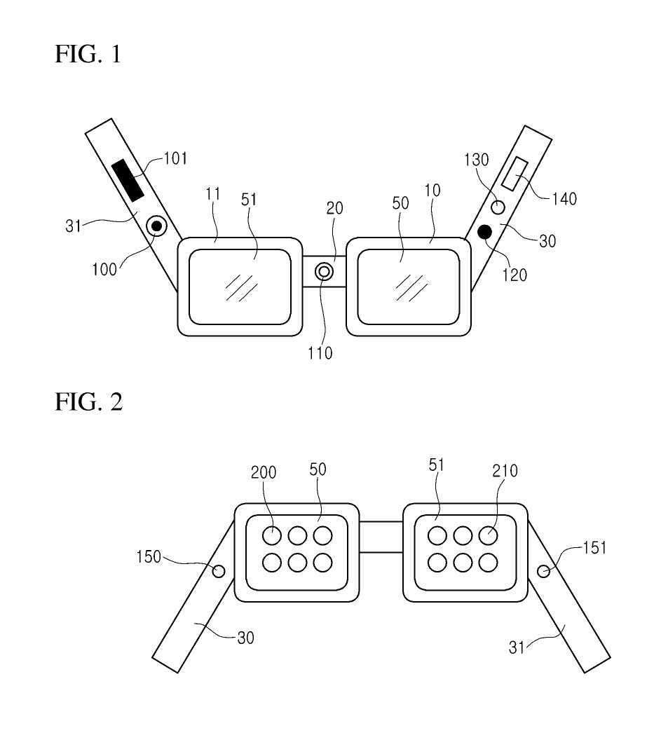

FIG. 1 and FIG. 2 are perspective views showing a wearable electronic device according to an exemplary embodiment of the present invention. FIG. 1 corresponds to a front view of the wearable electronic device.

Referring to FIG. 1, a wearable electronic device 1 may be embodied as a glass. The wearable electronic device 1 includes left and right lens frames 10 and 11, a frame connector 20, left and right side arms 30 and 31 and left and right lenses 50 and 51.

On the other hand, an image capturing device may be installed at front side of the wearable electronic device 1. For example, a camera 110 may be formed at the frame connector 20 as shown in FIG. 1.

Therefore, a user can wear the wearable electronic device to take a picture or a video and to store and to share it while moving.

In this case, there exists a merit that the view point of the image captured by the camera is similar to the view point of the user.

Further, a gesture such as a hand motion of a user can be recognized by the camera 110 so that the wearable electronic device 1 can be controlled by the gesture.

The position or the number of the camera 110 may be changed as required, and a specific camera such as an infrared camera may be employed.

Additionally, various units for performing specific function may be installed at the left and right arms 30 and 31, respectively.

A user interface device receiving an input of a user for controlling the wearable electronic device 1 may be installed at the right arm 31.

For example, a track ball 100 or a touch pad 101 for moving a cursor or selecting object such as a menu may be installed at the right arm 31.

The user interface device installed at the wearable electronic device 1 is not limited to the track ball 100 and the touch pad 101, but the user interface may include various input devices such as a key pad, a dome switch, a jog wheel, a jog switch, etc.

On the other hand, a microphone 120 may be installed at the left arm 30, so that the wearable electronic device 1 may be controlled by using a voice inputted by the microphone 120.

Additionally, a sensing part 130 may be installed at the left arm 30 for sensing a present status or a user-related information such as a position of the wearable electronic device 1, a contact of a user, a point of a compass, an acceleration/deceleration, etc. to generate sensing signal for controlling the wearable electronic device 1.

For example, the sensing part 130 may include additionally various sensors for sensing various information such as a motion sensor such as a gyroscope, an accelerometer, etc., a position sensor such as a GPS sensor, a magnetometer, a direction sensor such as theodolite, a temperature sensor, a humidity sensor, a wind direction sensor, an air flow sensor, etc.

For example, the sensing part 130 may further include an infrared sensor including an infrared-ray generating section and an infrared-ray receiving section for infrared-ray communication or detecting proximity degree.

The wearable electronic device 1 may further include a communication part 140 for communicating with an external device.

For example, the communication part 140 may include a broadcast receiving module, a mobile communication module, a wireless internet module and a local area communication module, etc.

The broadcast receiving module receives a broadcast signal and/or information related to broadcast from an external broadcast management server through broadcasting channels. The broadcasting channels may include satellite channels and terrestrial channels. The broadcast management server may mean a server generating and transmitting a broadcast signal and/or information related to broadcast to a terminal or a server receiving and transmitting a broadcast signal and/or information related to broadcast, which are previously generated, to a terminal. The information related to broadcast may mean information regarding to a broadcast channel, a broad cast program or a broadcast service provider. The broadcast signal may include not only a TV broadcast signal, a radio broadcast signal, a data broadcast signal but also a broadcast signal in which a TV broadcast signal is merged with a data broadcast signal or a radio broadcast signal is merged with a data broadcast signal.

On the other hand, the information related to broadcast may be provided through a mobile communication network, and in this case, the information related to broadcast may be received by a mobile communication module.

The information related to broadcast may have a various format. For example, the information related to broadcast may be electronic program guide (EPG) of digital media broadcasting (DMB), or electronic service guide (ESG) of digital video broadcast-handheld (DVB-H), etc.

The broadcast receiving module may receive, for example, a digital broadcast signal by using a digital broadcast system such as digital multimedia broadcasting-terrestrial (DMB-T), digital multimedia broadcasting-Satellite (DMB-S), media forward link only (MediaFLO), digital video broadcast-handheld (DVB-H), integrated services digital broadcast-terrestrial (ISDB-T), etc. The broadcast receiving module may be embodied such that the broadcast receiving module is proper not only to the above digital broadcast system but also to all broadcast system providing broadcast signals.

The broadcast signal and/or the information related to broadcast that are received through the broadcast receiving module may be stored in a memory.

The mobile communication module receives wireless signal from at least one of a base station of mobile communication network, an external terminal and a server and transmits wireless signal to at least one of a base station of mobile communication network, an external terminal and a server. The wireless signal may include various formatted data in accordance with voice call signal, videotelephony call signal or character/multimedia message receiving and transmitting.

The wireless internet module is a module for connection to wireless internet, and the wireless internet module may be embedded or outer mounted. Wireless LAN (WLAN) Wi-Fi), Wireless broadband (Wibro), World Interoperability for Microwave Access (Wimax), High Speed Downlink Packet Access (HSDPA), etc. may be used as the wireless internet technology.

The local area communication module means a communication module in a local area. Bluetooth, radio frequency identification (RFID), infrared data association (IrDA), ultra wideband (UWB), zigbee, etc. may be used as the local area communication technology.

The wearable electronic device 1 according to an exemplary embodiment may include a display device for displaying an image to deliver information to a user.

In order that a user can see a front view together with an image displayed by the display device, the display device may include a transparent or a light-transmitting unit.

For example, at least one of the left and right lenses 50 and 51 may operate as the transparent display so that a user can see a front view together with text or image displayed on at least one of the left and right lenses 50 and 51.

In order for that, a head mounted display (HMD) or a head up display (HUD) may be used as the wearable electronic device 1 to display various image in front of eye of a user.

The HMD includes a lens for magnifying an image to form a virtual image, and a display panel disposed closer than a focal distance of the lens. When the HMD is mounted on a head of a user, the user can see an image displayed on the display panel to recognize a virtual image.

On the other hand, according to the HUD, an image displayed through the display panel is magnified through a lens, the magnified image is reflected by a half mirror, and the reflected image is shown to a user to form a virtual image. The half-mirror can transmits external light so that a user can the virtual image formed by the HUD passing through the half-mirror together with the front view.

Further, the display device can be embodied through various transparent display such as transparent OLED (TOLED).

Hereinafter, the wearable electronic device 1 employs, for example, the HUD, but the present invention is not limited to the HUD.

FIG. 2 corresponds to a back view of the wearable electronic device. Referring to FIG. 2, the HUDs 150 and 151 operating a function like a projector may be installed at a backside of at least one of the left arm 30 and the right arm 31.

When the image generated by light projected by the HUDs 150 and 151 and reflected by the left and right lenses 50 and 51 is shown to a user, an object 200 generated by the HUDs 150 and 151 is displayed on the left and right lenses 50 and 51 to be shown the user.

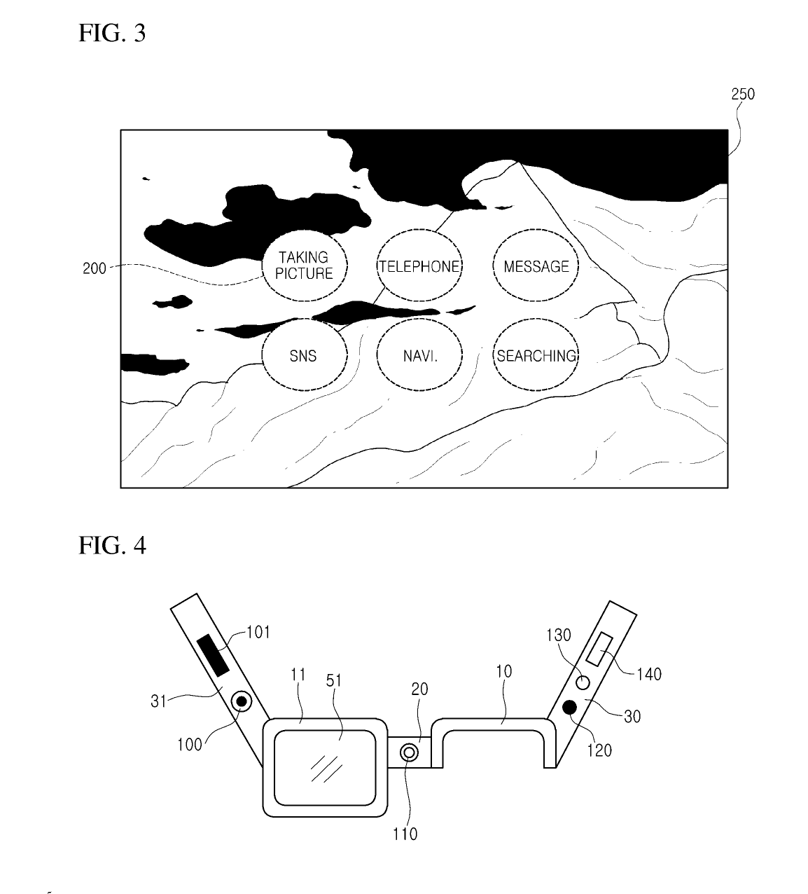

In this case, as shown in FIG. 3, the object 200 displayed on the left and right lenses 50 and 51 can be observed by the user together with the front view 250.

The object 200 displayed on the left and right lenses 50 and 51 by the HUDs 150 and 151 is not limited to menu icon as shown in FIG. 3 but may be a text, a picuture or a moving picture.

Through structure of the wearable electronic device 1, which is explained above, the wearable electronic device 1 can operate functions of taking a picture, telephone, message, social network service (SNS), navigation, search, etc.

The wearable electronic device 1 may have various functions except the above in accordance with modules installed thereto.

For example, a moving picture captured by the camera 110 may be provided to SNS server through the communication part 140 to share it with other users. Therefore, the wearable electronic device 1 may perform functions in which more than one of functions of above is merged.

Additionally, the wearable electronic device 1 may have function of 3D glasses which shows 3D image to a user.

For example, as an external display device displays a left-eye image or a right-eye image alternatively by frame, the wearable electronic device 1 alternatively open and shut each of the left and right eyes to make a user feel 3D image.

That is, the wearable electronic device 1 opens a shutter of left eye when the display device displays left-eye image, and the wearable electronic device 1 opens a shutter of right eye when the display device displays right-eye image, so that a user can feel three-dimensional effect of 3D image.

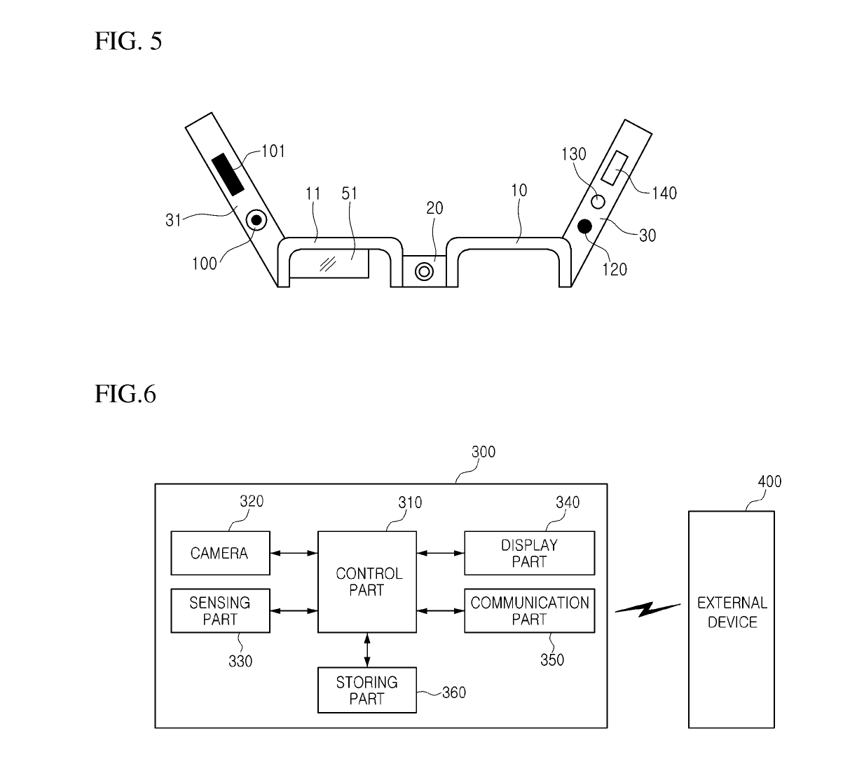

FIG. 4 and FIG. 5 are perspective views showing a wearable electronic device according to another exemplary embodiment of the present invention.

Referring to FIG. 4, the wearable electronic device 1 may have only one of the left and right lenses (for example, right lens 51), so that the image displayed by internal display devices such as HUD can be shown only to one eye.

Referring to FIG. 5, the wearable electronic device 1 do not include lens at one of sides (for example, left side), and include lens 11 covering only upper portion at the other side (for example, right side).

Shapes and structures of the wearable electronic device 1 may be changed as required according to a used field, a main function, a user group, etc.

Hereinafter, referring to FIG. 6 through FIG. 10, the wearable electronic device and a method of controlling the wearable electronic device will be explained in detail.

FIG. 6 is a block diagram showing a structure of a wearable electronic device according to an exemplary embodiment of the present invention.

Referring to FIG. 6, the wearable electronic device 300 according to an exemplary embodiment of the present invention may include a control part 310, a camera 320, a sensing part 330, a display part 340, a communication part 350 and a storing part 360.

The control part 310 controls functions of the wearable electronic device 300. For example, the control part 310 controls and performs a process regarding to an image capturing, a telephone, message, SNS, navigation, search, etc. Additionally, the control part 310 may include a multimedia module (not shown) for playing multimedia. The multimedia module may be embedded into the control part 310 or separately formed with the control part 310.

The control part 310 may include one or more than one processor and memory to perform the above functions, and receives signals from the camera 320, the sensing part 330, the display part 340, the communication part 350 and the storing part 360 to process the signal.

The camera 320 processes image frame of stopped image or video obtained by an image sensor in videotelephony mode or image capturing mode, and the processed image frame may be displayed through the display part 340.

The image frame processed by the camera 320 may be stored by the storing part 360 or sent to outside through the communication part 350. More than one camera 320 may be installed at different position when required.

The sensing part 330 may perform a function of the sensing part 130.

The strong part 360 may store a program for an operation of the control part 310, and inputted/outputted data (for example, message, a stopped image, a video, etc.) temporally.

The storing part 360 may include at least one of flash memory, hard disk, a multimedia card micro type, card type memory (for example SD or XD memory), random access memory (RAM), static random access memory (SRAM), read-only memory (ROM), electrically erasable programmable read-only memory (EEPROM), programmable read-only memory (PROM), magnetic memory, magnetic disc, optical disc, etc.

Further, the wearable electronic device 300 may operate in corporate with a web storage performing storing function of the storing part 360 in internet.

The display part 340 displays (or outputs) information processed by the wearable electronic device 300. For example, when the wearable electronic device 300 is in a telephone mode, the display part 340 displays a user interface (UI), or a graphic user interface (GUI) regarding to the telephone mode. When the electronic device 300 is in a videotelephony mode or an image capturing mode, the display part 340 displays UI or GUI regarding to the videotelephony mode or the image capturing mode.

The display part 340 may be embodied through a transparent display such as the HMD, HUD, TOLED etc. in order that a user can see a front view together with an object displayed by the display part 340.

The communication part 350 may include one or more than one communication modules for data communications with an external device 400. For example, the communication part 350 may include a broadcast receiving module, a mobile communication module, a wireless internet module, a local area communication module and a position information module.

The wireless electronic device 300 may further include an interface part (not shown) operating as a passage for all external devices connected to the wireless electronic device 300.

The interface part receives data from an external device or electric power to provide it to each element of the wearable electronic device 300 or transmits internal data of the wearable electronic device 300 to an external device.

For example, the interface part may include a wire/wireless headset port, a battery charger port, a wire/wireless data port, a memory card port, a port for connecting a device with a recognition module, an audio I/O port, a video I/O port, an ear phone port, etc.

The recognition module is a chip for storing various informations for certifying authority of use. For example, the recognition module may include an user identifying module (UIM), a subscriber identifying module (SIM), a universal subscriber identifying module (USIM), etc. The device with recognition module (hereinafter ‘recognition device’) may be embodied as a smart card. Therefore, the recognition device may be connected to the wearable electronic device 300 through a port.

Further, the interface part may be a passage through which a power of a cradle is provided to the wearable electronic device 300, when the wearable electronic device 300 is connected to the external cradle, or the interface part may be a passage through which various order signals inputted to a cradle by a user are provided to a mobile terminal. The various order signals inputted from a cradle or the power may be a signal for recognition that the mobile terminal is exactly mounted to the cradle.

The wearable electronic device 300 may further include a power supply (not shown) providing internal electric power or outer electric power provided from outside to each element through a control of the control part 310. The power supply may include a solar charge system.

The various embodiments described here may be embodied through a computer readable media which is readable by a computer or other system like a computer by software, hardware or the combination thereof. For example for hardware embodiment, the embodiments may be embodied by using at least one of an application specific integrated circuits (ASICs), a digital signal processors (DSPs), a digital signal processing devices (DSPDs), a programmable logic devices (PLDs), a field programmable gate arrays (FPGAs), a processor, a controller, a micro-controller, a microprocessor, an electric unit for performing operation. For some case, these embodiments may be embodied through the control part 180.

For example for software embodiment, embodiments such as a process or performance may be embodied through a combination of separate software module performing one process or one performance. Software codes may be embodied through proper language and software application for the proper language. The software codes may be stored in the memory part 360 and performed through the control part 310.

Hereinafter, the wearable electronic device and the method of controlling the wearable electronic device will be explained in detail based on the structure of the wearable electronic device 300 described above.

The wearable electronic device 300 may include the user interface device receiving a user input, and the user interface device may receive a user input for selecting operation mode of the wearable electronic device 300. The operating mode of the wearable electronic device may include a transparent mode and an opaque mode.

Further, the user interface device may receive a user input for selecting transparent/opaque levels in the transparent/opaque mode.

The camera 320 may take a picture of front view shown to a user wearing the wearable electronic device 300. In this case, the camera 320 may generate an image corresponding to the front view of a user (hereinafter, referred to as ‘real image’). If the selected mode is the opaque mode, the real image generated by the camera 320 may be provided to a portion of region of a contents providing screen of the wearable electronic device 300 as a sub screen. The size and position of the sub screen may be selected by a user through the user interface device.

The control part 10 may analyze the real image generated by the camera 320. In this case, when the present situation is determined to be attention situation or urgent situation, the control part 310 may alarm a user, change the opaque mode in which a user see a contents to be the transparent mode, or stop contents display according to an initial setting function, a present usage function or a user setting function. In this case, the control part 310 may determine the present situation to be the attention situation or the urgent situation when a size of an object in the real image becomes a larger than a specific size as the object becomes closer to a user or when an object of which size is larger than a specific size moves fast. Therefore, when a user wearing the wearable electronic device 300 enjoy the contents in the opaque mode, the wearable electronic device 300 recognizes an approaching person or car to let him know or to change the opaque mode to be the transparent mode so that the user can see the front view.

The control part 310 controls a liquid crystal to change between the opaque mode and the transparent mode of the wearable electronic device 300. The liquid crystal may be polymer dispersed liquid crystal (PDLC), suspended particle devices SPD) or LC shutter. The liquid crystal may be disposed on a light path from a front view to an eye of a user to adjust light transmittance of the front view in accordance with the eye of the user. For example, the liquid crystal may be disposed at front side or backside of the lens of the wearable electronic device 300.

Therefore, the control part 310 controls the liquid crystal to adjust light transmittance of the front view recognized by a user wearing the wearable electronic device 300 so that the wearable electronic device 300 changes the mode between the opaque mode and the transparent mode.

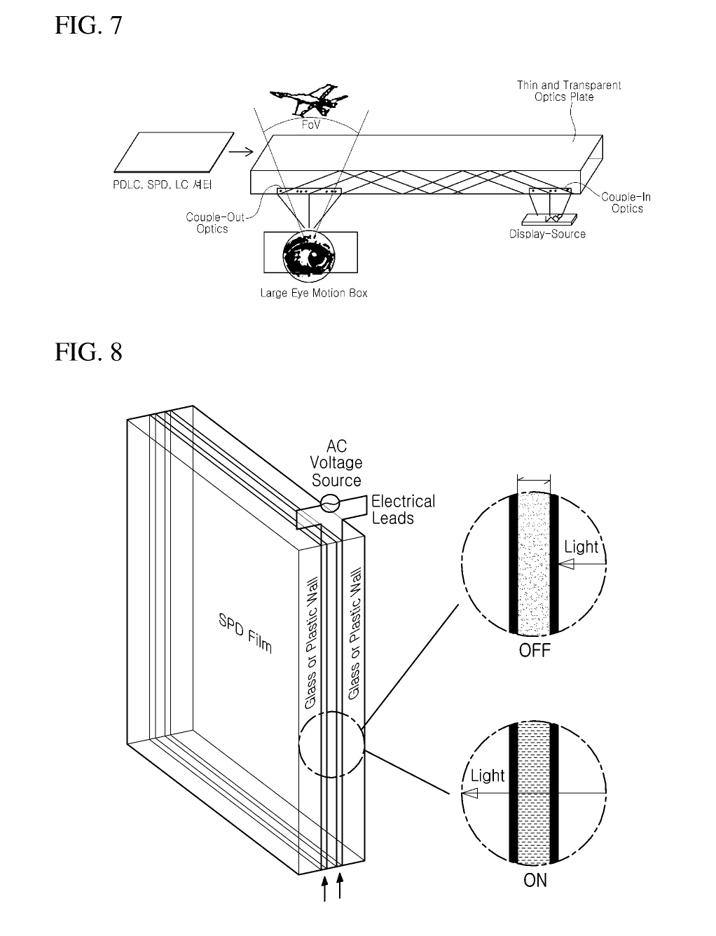

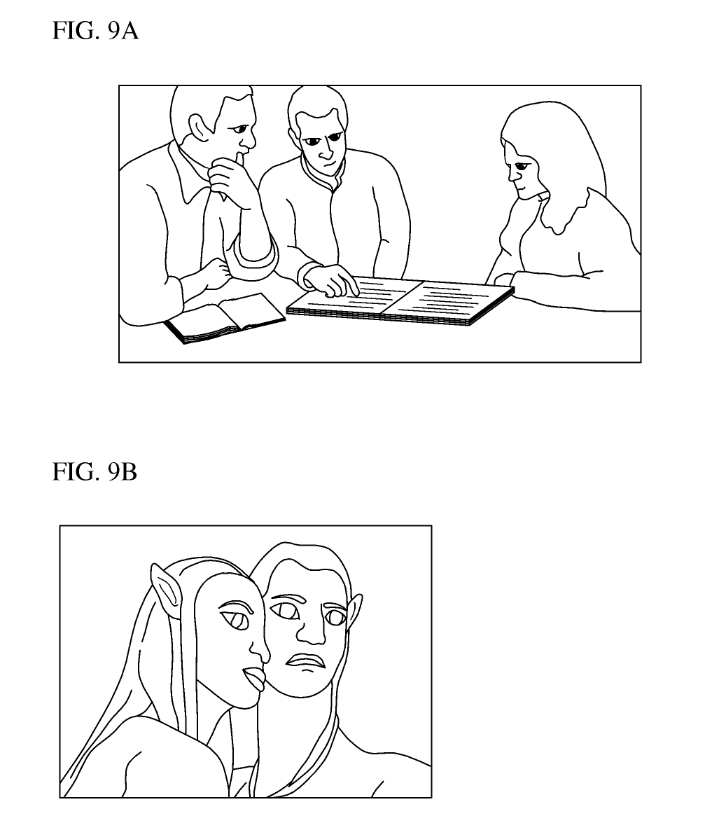

The liquid crystal adjusting the light transmittance will be explained referring to FIG. 7 and FIG. 8.

FIG. 7 is a schematic view showing adjustment of light transmittance of polymer dispersed liquid crystal (PDLC), suspended particle devices SPD) or LC shutter installed at the wearable electronic device according to an exemplary embodiment of the present invention.

Referring to FIG. 7, the PDLC, the SPD or the LC shutter is disposed at front side or backside of the lens, and the control part 310 can adjust light transmittance of the front view in accordance with the eye of the user wearing the wearable electronic device 300.

The following table 1 shows the difference between the SPD and LC shutter.

TABLE 1

| | | SPD |
|---|---|---|
| | LC shutter | Nonpolarization/Partial |
| Polarization | Polarization | Polarization |
| Light transmittance | 1~50% | 10~80% |
| Gray scale presentation | Good | Good |
| Response time | No longer than 10 ms | 100 ms |
| Driving voltage | 3 V | 30~100 V |
| Transmittance when | Transparent | Opaque |
| voltage OFF | | |

FIG. 8 is a schematic perspective view showing SPD.

Referring to FIG. 8, millions particles are disposed two transparent glasses or plastic plate on which transparent conductive materials are coated on inner surfaces thereof. When electric power is applied to the transparent conductive coating, the particles are rearranged to adjust light transmittance. Therefore, the wearable electronic device 300 can be changed between the opaque mode and the transparent mode.

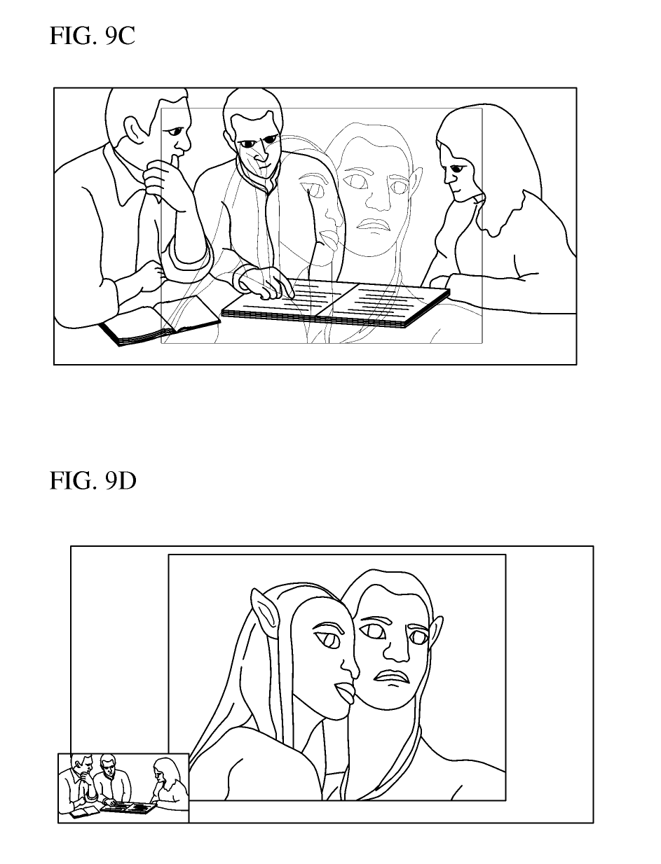

FIG. 9A is a schematic view of real image, FIG. 9B is a schematic view of contents that is a moving picture, FIG. 9C is a schematic view of enjoying the contents of FIG. 9B in a transparent mode, and FIG. 9D is a schematic view of enjoying the contents of FIG. 9B in an opaque mode.

As shown in FIGS. 9A and 9C, the wearable electronic device may be used in the transparent mode (maximum transmittance SPD 80% or LC shutter 50%). In the transparent mode, the wearable electronic device may be used for augmented reality. As shown in FIG. 9B and FIG. 9D, the wearable electronic device may be used in the opaque mode so that a user can enjoy the contents with the front view blocked. Further, as shown in FIG. 9D, when a user enjoys the contents in the opaque mode, the camera 320 of the wearable electronic device takes a moving picture of the front view to provide the moving picture of the front view to a portion of the screen as a sub screen. Therefore, a user can properly deal with people around, and prepare to environment to protect the user while enjoying the contents.

Further, when enjoying the contents in the opaque mode, the control part 310 recognize the real image of the camera to alarm a user, to change the opaque mode in which a user see a contents to be the transparent mode, or to stop contents display when the present situation is attention situation or urgent situation. In this case, the control part 310 may determine the present situation to be the attention situation or the urgent situation when a size of an object in the real image becomes a larger than a specific size as the object becomes closer to a user or when an object of which size is larger than a specific size moves fast. Therefore, when a user wearing the wearable electronic device 300 enjoy the contents in the opaque mode, the wearable electronic device 300 recognizes an approaching person or car to let him know or to change the opaque mode to be the transparent mode so that the user can see the front view.

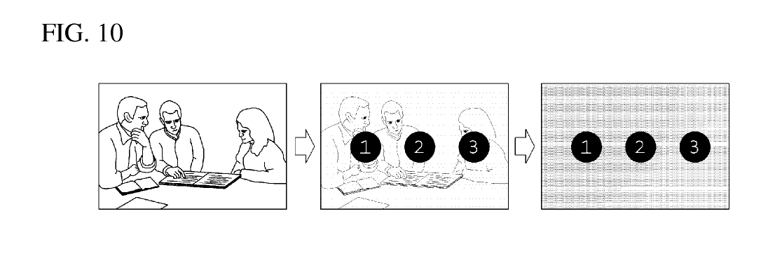

FIG. 10 is a figure for explaining a selection of transparent/opaque level in the transparent mode/the opaque mode.

Referring to FIG. 10, the wearable electronic device can receive a user input regarding the transparent/opaque level, and then the control part 310 can adjust the transparent/opaque level by controlling the liquid crystal in accordance with the selected level.

The above explained methods can be embodied through a program code to be stored in non-transitory computer readable medium to be provided to a server or various apparatuses.

The non-transitory computer readable medium is not a medium transitorily storing data such as a register, a cash, a memory, etc., but stores data semipermanently. The non-transitory computer readable medium can be read by an apparatus such a computer. In detail, the various applications and programs may be stored in CD, DVD, hard disk, blue ray disk, USB, memory card, ROM, etc.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A wearable electronic device comprising:
a transparent or light-transmitting lens;
a liquid crystal installed at the lens;
a camera taking a picture of a front view of a user wearing the wearable electronic device;
a display part displaying an additional information to the lens, which is added to a front view recognized by the user; and
a control part determining an operation mode of the wearable electronic device whether the operation mode is a transparent mode or an opaque mode, controlling liquid crystal to adjust light transmittance according to the determined operation mode, and controlling the display part to display the additional information when the operation mode is changed to be the transparent mode or the opaque mode.

2. The wearable electronic device of claim 1, further comprising:
an input part receiving a user input for operating the wearable electronic device in the transparent mode or the opaque mode, wherein the input part further receives a user input for selecting a transparent level of the transparent mode or an opaque level of the opaque mode.

3. The wearable electronic device of claim 1, wherein the liquid crystal is polymer dispersed liquid crystal (PDLC), a suspended particle device (SPD) or LC shutter, and the liquid crystal is disposed at a front side or a backside of the lens.

4. The wearable electronic device of claim 1, wherein the control part determines an urgent situation by using a front view captured by the camera when the user enjoys contents in the opaque mode, and
controls the liquid crystal to change the opaque mode to be the transparent mode when the control part determines that current situation is the urgent situation, stops the contents, or provides alarms to the user.

5. A method of controlling a wearable electronic device having a transparent or light-transmitting lens and a liquid crystal disposed at the lens to adjust light transmittance, the method comprising:
capturing a front view recognized by a user wearing the wearable electronic device;
determining an operation mode of the wearable electronic device to be a transparent mode or an opaque mode;
controlling the liquid crystal to adjust light transmittance according to the determined operation mode; and
controlling providing an additional information to the front view when the operation mode is changed to be the transparent mode or the opaque mode.

6. The method of claim 5, further comprising:
receiving an user input for operating the wearable electronic device in the transparent mode or in the opaque mode; and
receiving an user input for selecting a transparent level of the transparent mode or an opaque level of the opaque mode.

7. The method of claim 5, wherein the liquid crystal is polymer dispersed liquid crystal (PDLC), a suspended particle device (SPD) or LC shutter, and the liquid crystal is disposed at a front side or a backside of the lens.

8. The method of claim 5, further comprising:
determining an urgent situation by using the captured front view, when the user enjoys contents in the opaque mode; and
controlling the liquid crystal to change the opaque mode to be the transparent mode when the a current situation is determined to be the urgent situation, stops the contents, or provides alarms to the user.
